(19) United States
(12) Patent Application Publication
(10) Pub. No.: US 2025/0337173 A1
(43) Pub. Date: Oct. 30, 2025

(54) RADIO FREQUENCY CHIP ARRANGEMENT, SENSOR AND METHOD OF MANUFACTURE

(71) Applicant: VEGA Grieshaber KG, Wolfach (DE)

(72) Inventors: Daniel SCHULTHEISS, Hornberg (DE); Christoph MUELLER, Oppenau (DE); Christian WEINZIERLE, Wolfach (DE)

(73) Assignee: VEGA Grieshaber KG, Wolfach (DE)

(21) Appl. No.: 19/195,204

(22) Filed: Apr. 30, 2025

(30) Foreign Application Priority Data
Apr. 30, 2024 (DE) 10 2024 112 205.6

(51) Int. Cl. H01Q 19/06; H01Q 1/38; H01Q 15/08; H01Q 19/09

(52) U.S. Cl. CPC H01Q 19/062; H01Q 1/38; H01Q 15/08; H01Q 19/09

(57) ABSTRACT

A radio frequency chip arrangement is provided, including: a radio frequency chip configured to emit and to receive radio frequency waves; a first housing having a cavity, including a housing cover and a carrier substrate, the first housing surrounding the radio frequency chip when the housing cover is attached to the carrier substrate, the radio frequency chip being arranged on a top surface of the carrier substrate so as to radiate the radio frequency waves away from the carrier substrate, and the carrier substrate, the radio frequency chip, and the first housing form a module; and a second housing, which surrounds at least the module, an intermediate space between the module and the second housing being filled with a potting compound, so that the module is completely surrounded by the potting compound and the radio frequency waves pass through the first housing, the potting compound, and the second housing.

### REFERENCE TO RELATED APPLICATIONS

The present application claims priority under 35 U.S.C. § 119 from German patent application No. 10 2024 112 205.6, filed on Apr. 30, 2024, which is incorporated herein by reference in its entirety.

### TECHNICAL FIELD

The invention relates to a radio frequency chip arrangement, an industrial sensor, and a method of manufacturing the radio frequency chip arrangement.

### BACKGROUND

In radio frequency chip arrangements, for example for level sensors, the radio frequency (RF) signal is routed from the radio frequency chip via a bond connection to a separate radiating element that is spaced from the radio frequency chip and emits the radar waves. The radio frequency chip to protect the chip and the bond wires are then provided with a so-called globtop, i.e., a potting. When using radar frequencies above 100 GHz, such conventional construction technologies are no longer possible. Instead, in these cases the RF signal is usually emitted directly from the RF chip via a primary radiator. This requires the chip to be operated as far as possible without any interfering ambient medium. In the case of radar sensors used in explosion-proof areas, however, it is common practice to encapsulate the electronics. This changes the dielectric properties around the chip and worsens its RF properties, so that encapsulation of the chip is not possible.

### SUMMARY

One objective of the invention could therefore be to provide an improved radio frequency chip arrangement for radar frequencies above 100 GHz in explosion-proof areas.

The objective is solved by the subject matter of the independent claims. Advantageous embodiments are the subject of the dependent claims, the following description and the figures.

The described embodiments similarly relate to the radio frequency chip arrangement, an industrial sensor and a method of manufacturing the radio frequency chip arrangement. Synergy effects may result from various combinations of the embodiments, although they may not be described in detail.

It should further be noted that all embodiments of the present invention relating to a method may be carried out in the described order of steps, but this need not be the sole and essential order of steps of the method. The methods presented herein may be carried out with a different order of the disclosed steps without deviating from the respective method embodiment, unless expressly stated otherwise below.

Technical terms are used in the usual way. If certain terms are assigned a specific meaning, definitions of terms are given below, in the context of which the terms are used.

According to a first aspect, a radio frequency chip arrangement is provided. The radio frequency chip arrangement comprises a radio frequency chip configured to radiate and receive radio frequency waves, and a first housing having a cavity, comprising a housing cover and a carrier substrate, wherein the first housing surrounds the radio frequency chip when the housing cover is attached to the carrier substrate. The radio frequency chip is arranged on a top surface of the carrier substrate such that it radiates radio frequency waves away from the carrier substrate. The carrier substrate, the radio frequency chip and the first housing form a module. The radio frequency chip arrangement has a second housing which surrounds at least the module, wherein an intermediate space between the module and the second housing is filled with a potting compound so that the module is completely surrounded by the potting compound and the radio frequency waves pass through the first housing, the potting compound and the second housing.

### BRIEF DESCRIPTION OF THE FIGURES

In the following, embodiments of the invention are explained in more detail with reference to the schematic drawings.

FIG. 1 shows a diagram of a first, general embodiment of a radio frequency chip arrangement.

FIG. 2 shows a diagram of a second embodiment of a radio frequency chip arrangement.

FIG. 3 shows a diagram of a third embodiment of a radio frequency chip arrangement.

FIG. 4 shows a diagram of a fourth embodiment of a radio frequency chip arrangement.

FIG. 5 shows a diagram of a fifth embodiment of a radio frequency chip arrangement.

FIG. 6 shows a flow chart of a method.

FIG. 7 shows a diagram of an industrial sensor.

### DETAILED DESCRIPTION OF EMBODIMENTS

Corresponding parts are marked with the same reference signs in all figures.

The radio frequency chip arrangement is particularly suitable for use in a potentially explosive environment. This is achieved by the two housings, in which the first, inner housing has a cavity that is gas-filled or air-filled, or contains a vacuum and thus does not change the dielectric properties around the chip and therefore its RF properties do not deteriorate. There is a potting compound between the first and second housing to ensure explosion safety.

The second housing surrounds at least the module. The module can be mounted on a circuit board, for example, so that the second housing also surrounds the circuit board. This means that the module is also completely surrounded by the potting compound in this case. The carrier substrate can be limited to the dimensions of the housing cover, i.e., the dimensions of the edges of the housing cover that are in contact with the carrier substrate. In particular, the module can be an independently mountable arrangement, which can then be mounted as a module or “package” on the printed circuit board, soldered, glued, or otherwise attached to the printed circuit board. However, the term “module” should also include the case where the carrier substrate forms a surface of a printed circuit board or PCB. The printed circuit board can be considered part of the radio frequency chip arrangement. In one view, however, the module can also include the printed circuit board or at least the part of the printed circuit board that is bounded by the housing. The terms “in the module” or “within the module” are equivalent to “in the first housing” or “within the first housing. The term “top side” of the carrier substrate means the side that is in contact with the housing. The underside of the carrier substrate is connected to the printed circuit board, for example. The carrier substrate thus forms the base for the first housing. The housing cover can consist at least partially of an RF-permeable material, e.g., plastic or ceramic, and seal the housing tightly.

It is understood that the radio frequency chip arrangement is bi-directional and that RF waves, for example radar waves, are both emitted by it, e.g., to a filling material, and reflected and received by it, e.g., by the filling material, even if the receiving direction is not explicitly mentioned or described in all cases in this disclosure. The term “pass” is to be equated with “pass through” or “penetrate”. This means that the radio frequency waves pass through the first housing, penetrate the potting compound, and pass through the second housing. The radio frequency waves can pass through the second housing, the potting compound, and the first housing in the opposite way. An essential point of the radio frequency chip arrangement is that the first housing does not contain a potting compound but encloses air, but the second housing is filled with a potting compound. The first housing and the second housing are spaced apart from each other in all dimensions so that the potting compound completely surrounds the module. The arrangement is suitable for use in a potentially explosive environment in which, for example, gases can ignite. The radio frequency chip is isolated from the environment by the arrangement. At the same time, the first housing keeps the encapsulation material away from the radio frequency chip so as not to adversely affect the electrical properties in terms of wave generation and radiation.

In the following embodiments, advantageous features for boundary conditions are described as well as options for how the radar beams are guided through the housings and the potting compound.

According to an embodiment, the first housing encloses a space whose maximum volume corresponds to an explosion protection value. Advantageously, the housing encloses a space whose air inclusion volume is less than 5 cm³, 3 cm³ or 2 cm³, but in particular less than 1 cm³.

The size of the air pocket should be sufficiently small to limit the amount of flammable gases or vapors available in the event of an explosion. A specification from a standard could have to be observed here, e.g., less than 1 cm³. A smaller air inclusion limits the potential for an explosion. This means that the first enclosure is large enough not to degrade the RF properties, but also small enough to ensure explosion safety.

An explosion protection value is a value that can be used, for example, as a threshold value and that has been determined in advance in order to avoid or prevent an explosion that would be triggered, for example, by spontaneous heat generation in particular, or to keep an explosion low and/or localized. Furthermore, an explosion protection value can be a value or a derived value of a standard.

According to an embodiment, the module has first means for influencing the beam opening angle of the radio frequency waves, and the second housing has an area on which the radio frequency waves impinge according to the beam opening angle and a path of the radio frequency waves at least through the potting compound, which has second means for influencing the beam opening angle of the radio frequency waves.

This forms a beam focusing system consisting of several components. The beam opening angle is the opening angle at which the radio frequency waves are ultimately emitted from the radio frequency chip arrangement. This angle can be influenced by widening, focusing or directing the radio frequency waves or the beam of radio frequency waves.

According to an embodiment, the first means are a dielectric waveguide attached to the radio frequency chip and/or a lens integrated into the first housing.

The waveguide and the integrated lens can either each individually represent the sole first means or they can be combined with each other. The housing cover of the first housing arranged over the radio frequency chip can, for example, be equipped with a lens contour, referred to here as a lens, which is suitable for bundling or expanding the radio frequency waves or RF signals as required. The radio frequency chip can illuminate the lens directly with a planar structure as a primary radiator or with an attached dielectric waveguide.

According to an embodiment, the second means are a lens integrated into the second housing, a dielectric waveguide and/or a waveguide.

In the second means, the dielectric waveguide, the integrated lens and the waveguide can also either each individually represent the sole second means or they can be combined with each other as desired, where this makes sense. Advantageously, the dielectric waveguide and the waveguide appear in combination. The dielectric waveguide enables, for example, feeding into a waveguide, which can then feed a horn antenna, for example, or directly illuminate a dielectric lens. The lens can also be integrated into the second housing.

According to an embodiment, the first means and the second means have concave or convex lenses or the first means and the second means are concave or convex lenses.

This allows the beam of radio frequency waves to be widened and/or bundled depending on the application, requirements, and overall structure of the chip arrangement.

According to an embodiment, the first means and/or the second means have convex lenses on one side.

According to an embodiment, the first means and the second means comprise lenses which are limited in dimension to an area illuminated by the radio frequency waves, respectively the first means and the second means are limited in dimension to an area illuminated by the radio frequency waves.

This makes it possible to achieve a smaller form factor for the lenses and thus the arrangement.

The concave or convex lenses are thus not necessarily extended to the entire surface of the housing part or wall through which the radio frequency waves pass, but only to the area on which the radio frequency waves impinge, or on which the majority of the waves impinge. For example, the lens of the first housing concentrates the radio frequency waves so that their impact area is narrowly limited. The lens can then be limited to this area.

According to an embodiment, the first housing and/or the second housing have a flat wall through which the radio frequency waves pass.

The shape of the housing is basically arbitrary. However, the lenses can be easily integrated thanks to the flat wall.

According to an embodiment, a wall thickness of a wall of the housing cover through which the radio frequency waves pass is at least 1 mm, and the sum of this wall thickness and a thickness of the potting compound through which the radio frequency waves pass is at least 3 mm.

According to an embodiment, a wall thickness of the housing cover in a region where the radio frequency waves pass the housing cover is a multiple of I/4, where I is a wavelength of the radio frequency waves.

According to an embodiment, the lens consists of the housing cover, the second housing and the potting compound.

The potting compound is therefore itself part of a lens, e.g., a gradient or multilayer lens. In this case, the two housings can also contain a lens, or instead merely represent windows that allow the radio frequency waves to pass through and form the boundary to the lens made of the potting compound. A potting compound with a low dielectric constant and low losses, such as EPIC RESINS® S7391-03, is advantageous, but other potting compounds, such as SYLGARD® 517, are also possible with appropriate matching. The potting compound can also have different layers with different permittivity. The potting compound can therefore be part of the beam focusing system.

According to an embodiment, the distance between the lens integrated in the first housing and the lens of the second housing assumes a defined value that depends on the dielectric properties of the encapsulation.

This means that the length of the path of the radio frequency waves through the potting compound, which corresponds to the specified distance, depends on the lens effects of all the lenses involved.

According to a further aspect, there is provided an industrial sensor comprising a radio frequency chip arrangement as described herein, electronics connected to the radio frequency chip, and a third housing in which the radio frequency chip arrangement is mounted.

The industrial sensor is, for example, a fill level sensor, a limit value sensor, or a radar sensor in robotics applications.

According to a further aspect, a method of manufacturing a radio frequency chip arrangement described herein is provided. The method has the following steps. In a first step, a radio frequency chip, a housing cover, a second housing, a carrier substrate, a printed circuit board and a potting compound are provided. In a second step, the radio frequency chip is mounted on the carrier substrate. This can be done by gluing or soldering, for example. In a third step, the first housing is mounted on the carrier substrate. In a fourth step, the module is soldered onto a printed circuit board. In a fifth step, the module with the circuit board is installed in a second housing. In a sixth step, the second housing is potted so that there is potting compound between the first housing and the second housing, and the first housing is enclosed by the potting compound.

### EXAMPLES

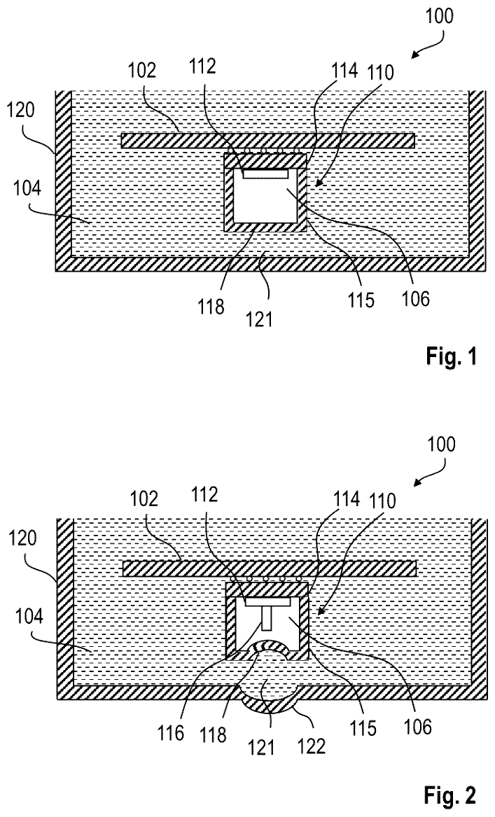

FIG. 1 shows a first embodiment of a radio frequency chip arrangement 100. The radio frequency chip arrangement 100 has a radio frequency chip 112, which is set up to emit and receive radio frequency waves, and a first housing 114, 115 having a cavity, e.g., filled with air, filled with gas or containing a vacuum, comprising a housing cover 115 and a carrier substrate 114. The housing 114, 115 thus encloses the radio frequency chip 112 when the housing cover 115 is attached to the carrier substrate 114, and a gas-filled interior 106. The housing cover 115 can, for example, be cylindrical with a “bottom” or pot-shaped. However, it can also assume any other shape, such as hemispherical or with a different number of edges. The radio frequency chip 112 is arranged on an upper side of the carrier substrate 114, which faces into the interior of the housing 114, 115, in such a way that it radiates the radio frequency waves away from the carrier substrate 114, that is, onto the opposite inner side of the housing 114, 115. In FIG. 1, this is the bottom of the cylindrical housing cover 115. The carrier substrate 114, the radio frequency chip 112 and the housing cover 115 of the first housing 114, 115 form a module 110. The radio frequency chip arrangement 100 further comprises a second housing 120. The second housing 120 can preferably also be cylindrical or can also assume any other geometric shape. Since it preferably also encloses a printed circuit board 102 with further electronic components, i.e., the electronics, on which the module 110 is mounted, the cylindrical second housing is also referred to in this disclosure as an “electronics cup”. The second housing 120 surrounds at least the module 110, wherein a space 121 between the module 110 and the second housing 120 is filled with a potting compound 104, so that the module 110 is completely surrounded by the potting compound 104. The radio frequency waves thus pass through the first housing 114, 115, the potting compound 104, and the second housing 120. More specifically, the radio frequency waves take the path from the radio frequency chip through the gas-filled housing interior 106, the bottom of the cylindrical housing cover 115, and the bottom of the cylindrical second housing 120 to the outside. The housing cover 115 is flat in the example of FIG. 1. Here, “flat housing cover 115” refers to the wall of the housing cover 115 through which the radio frequency waves pass. The same applies to the electronics cup 120. The wall thickness of these walls in the area of the RF propagation is preferably a multiple of I/4.

The housing cover 115 consists entirely or partially of an RF-permeable material, e.g., plastic or ceramic. It is soldered or glued onto the carrier substrate 112 so that the resulting first housing 114, 115 tightly closes the interior 106.

To ensure explosion protection, the wall thickness of the housing cover 115 is dimensioned to be at least 1 mm, and the sum of the wall thickness of the housing cover 115 and the minimum potting thickness between the first housing 114, 115 is at least 3 mm. The wall thickness of the electronics cup 120 does not have to be taken into account for explosion protection and can therefore be designed for optimum RF propagation.

In the embodiment shown in FIG. 2, a dielectric waveguide 116 is directly attached to the radio frequency chip 112. The bottom of the housing cover 115 has a first lens 118, and the bottom of the electronics cup 120 or the second housing 120 has a second lens 122. The lenses 118, 122 can be concave, convex or, as shown in FIG. 2, concave-convex.

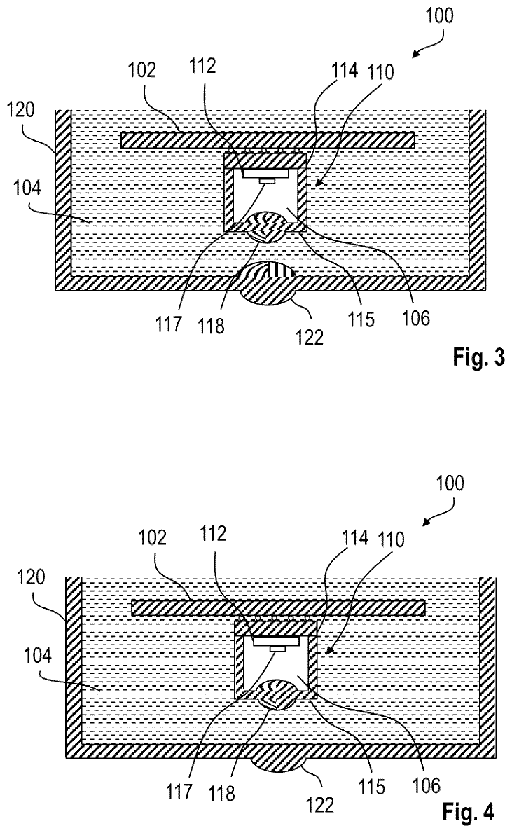

FIG. 3 shows another embodiment in which a primary radiator 117 is mounted directly on the chip 112 or on the carrier substrate 114 on which the radio frequency chip 112 is mounted. In the case shown in FIG. 3, the lenses 118, 122 are convex.

FIG. 4 shows another embodiment example with a housing cover 115 having a convex lens above the radio frequency chip 112, and a half convex lens in the electronics cup 120.

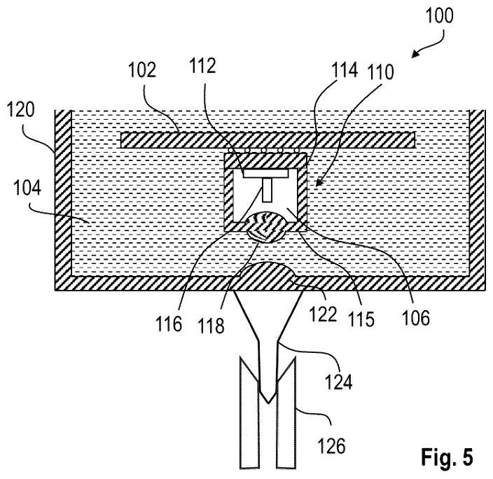

FIG. 5 shows a further embodiment example with a dielectric waveguide 124 arranged on the electronics cup 120. This can be manufactured in one piece with the electronics cup 120 or can be used subsequently from a material such as polypropylene (PP), high-density polyethylene (HDPE), polytetrafluoroethylene (PTFE), polyetheretherketone (PEEK), etc. The dielectric waveguide 124 in turn enables feeding into a waveguide 126, which can then, for example, feed a horn antenna or directly illuminate a dielectric lens.

The shapes of the housing cover 115 and the electronics cup 120 shown in FIGS. 1 to 5 can be combined as desired.

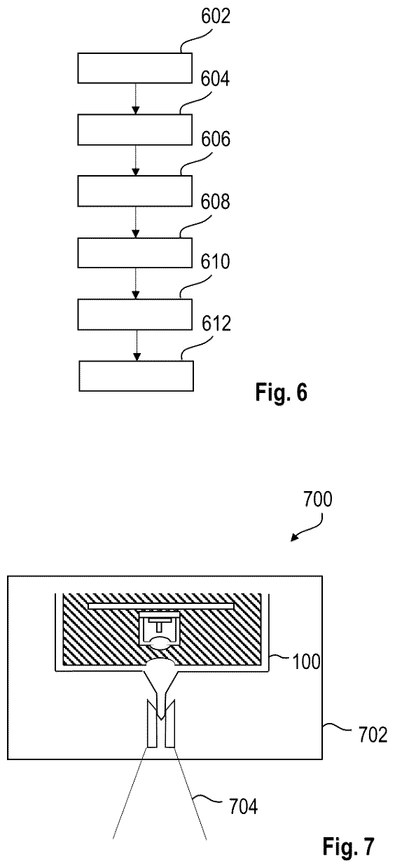

FIG. 6 shows a method of manufacturing a radio frequency chip arrangement 100 described herein. The method has the following steps:

In a first step 602, a radio frequency chip 112 is provided, as well as a housing cover 115, a second housing 120, a carrier substrate 114, a circuit board 102, and a potting compound (104);

In a second step 604, the radio frequency chip 112 is mounted on the carrier substrate 114. This can be done, for example, by gluing or soldering. In a third step 606, the first housing cover 115 is mounted on the carrier substrate 114 to obtain a first housing 114, 115 and a module 110. The carrier substrate 114 forms the basis for the housing 114, 115, which may also be referred to as a “package”. For example, the housing cover 115 is made of an RF-permeable material, such as plastic or ceramic. This creates a tightly sealed module 110 with the RF chip. In order to meet the explosion protection requirements, the enclosed volume (air entrapment) must be less than 1 cm³. The housing cover 115 is equipped above the RF chip 112, for example, with a lens contour, referred to herein as the first lens 118, which is suitable for bundling or expanding the RF waves as required. The RF chip 112 can thereby directly illuminate the first lens 118 with a planar structure as a primary radiator or with an attached dielectric waveguide 116. In a fourth step 608, the module 110 is soldered onto a printed circuit board 102. In a fifth step 610, the module with the circuit board 102 is installed in the second housing 120. In a sixth step 612, the second housing 120 is potted, that is, the potting compound 104 is filled so that potting compound 104 is located between the first housing 114, 115 and the second housing 120 and the first housing 114, 115 is enclosed by the potting compound 104. The distance between the lens 118 integrated in the housing cover 115 and the lens 122 incorporated in the electronics cup 120 assumes a defined value, which depends on the dielectric properties of the potting compound 104. A potting compound with a low dielectric constant and low losses, such as EPIC RESINS® S7391-03, is advantageous, but other potting compounds, such as SYLGARD® 517, are also possible with appropriate matching. The multilayer or gradient lens formed in this way can be used to illuminate another lens in a multi-lens system and direct the RF energy towards the product. In order to meet further explosion protection requirements, the wall thickness of the housing cover 115 must be at least 1 mm and the sum of the wall thickness of the housing cover 115 and the potting thickness must be at least 3 mm.

FIG. 7 shows an industrial sensor with the radio frequency chip arrangement 100 and a housing 702 of the sensor 700, referred to herein as the third housing 702. In the example of FIG. 7, the embodiment according to FIG. 5 has been used. However, any other embodiment described herein may be used instead. An industrial sensor is, for example, a level sensor, a point level sensor, a pressure sensor, a sensor that measures a density or a composition or mixture of a substance during a process. Such a sensor can be used in particular in process automation. However, such an industrial sensor can also be a radar sensor, for example, which is used in robotics.

Other variations of the disclosed embodiments may be understood and carried out by one skilled in the art in practicing the claimed invention by studying the drawings, the disclosure and the appended claims. In the claims, the word “comprising” does not exclude other elements or steps, and the indefinite article “one” or “a” does not exclude a plurality. A single processor or other unit may perform the functions of multiple items or steps recited in the claims. The mere fact that certain measures are specified in interdependent claims does not mean that a combination of these measures cannot be used advantageously. Reference signs in the claims should not be construed to limit the scope of the claims

### LIST OF REFERENCE SYMBOLS

100 Radio frequency chip arrangement
102 Printed circuit board
104 Potting compound
106 Cavity with air or gas entrapment or vacuum
110 Module
112 Radio frequency chip
114 Carrier substrate, base of the first housing Housing cover of the first housing
116 Dielectric waveguide
117 Primary radiator
118 First lens
120 Second housing, electronics cup
121 Space the module and the second housing
122 Second lens
124 Dielectric waveguide on the electronics cup
126 Waveguide
700 industrial sensor
702 third housing; housing of the industrial sensor
704 Horn antenna

1. A radio frequency chip arrangement, comprising:
a radio frequency chip configured to emit and to receive radio frequency waves;
a first housing having a cavity, comprising a housing cover and a carrier substrate,
wherein the first housing surrounds the radio frequency chip when the housing cover is attached to the carrier substrate,
wherein the radio frequency chip is arranged on a top surface of the carrier substrate so as to radiate the radio frequency waves away from the carrier substrate, and
wherein the carrier substrate, the radio frequency chip, and the first housing form a module; and
a second housing, which surrounds at least the module, an intermediate space between the module and the second housing being filled with a potting compound, so that the module is completely surrounded by the potting compound and the radio frequency waves pass through the first housing, the potting compound, and the second housing.

2. The radio frequency chip arrangement according to claim 1, wherein the first housing encloses a space whose maximum volume corresponds to an explosion protection value.

3. The radio frequency chip arrangement according to claim 1, wherein the module comprises first means for influencing a beam opening angle of the radio frequency waves, and the second housing comprises a region on which the radio frequency waves impinge according to the beam opening angle and a path of the radio frequency waves at least through the potting compound, which comprises second means for influencing the beam opening angle of the radio frequency waves.

4. The radio frequency chip arrangement according to claim 3, wherein the first means is a first lens integrated in the first housing and/or a dielectric waveguide attached to the radio frequency chip.

5. The radio frequency chip arrangement according to claim 4, wherein the second means are a lens integrated in the second housing, a dielectric waveguide, and/or a waveguide.

6. The radio frequency chip arrangement according to claim 5, wherein the first means and/or the second means comprise concave or convex lenses.

7. The radio frequency chip arrangement according to claim 5, wherein the first means and/or the second means comprise half-sided convex lenses.

8. The radio frequency chip arrangement according to claim 3, wherein the first means and the second means comprise lenses, which are limited in dimension to an area illuminated by the radio frequency waves.

9. The radio frequency chip arrangement according to claim 1, wherein the first housing and/or the second housing comprises a flat wall through which the radio frequency waves pass.

10. The radio frequency chip arrangement according to claim 1, wherein a wall thickness of a wall of the housing cover through which the radio frequency waves pass is at least 1 mm, and a sum of this wall thickness and a thickness of the potting compound through which the radio frequency waves pass is at least 3 mm.

11. The radio frequency chip arrangement according to claim 1, wherein a wall thickness of the housing cover in a region where the radio frequency waves pass the housing cover is a multiple of I/4, wherein I is a wavelength of the radio frequency wave.

12. The radio frequency chip arrangement according to claim 8, wherein the lenses comprise the housing cover, the second housing, and the potting compound.

13. The radio frequency chip arrangement according to claim 5, wherein a distance between the lens integrated in the housing cover and the lens of the second housing assumes a defined value that depends on dielectric properties of the encapsulation compound.

14. An industrial sensor comprising a radio frequency chip arrangement according to claim 1, electronics connected to the radio frequency chip, and a third housing in which the radio frequency chip arrangement is mounted.

15. A method of manufacturing a radio frequency chip arrangement according to claim 1, comprising the steps of:
providing a radio frequency chip, a housing cover, a second housing, a carrier substrate, a printed circuit board, and a potting compound;
mounting the radio frequency chip on the carrier substrate;
mounting the first housing cover on the carrier substrate to obtain a first housing and a module;
soldering the module onto the printed circuit board;
installing the module with the printed circuit board in the second housing; and
potting of the second housing, so that the potting compound is located between the first housing and the second housing and the first housing is enclosed by the potting compound.
